(19) United States
(12) Patent Application Publication
(10) Pub. No.: US 2007/0154177 A1
(43) Pub. Date: Jul. 5, 2007

(54) Apparatus and method of recording or reproducing content selection menu

(76) Inventor: Masanori Itoh, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/635,611

(22) Filed: Dec. 8, 2006

(30) Foreign Application Priority Data
Dec. 12, 2005 (JP) 2005-357416

(51) Int. Cl. H04N 7/00

(52) U.S. Cl. 386/95

(57) ABSTRACT

A data processing apparatus includes a recording unit operable to record content including video stream and/or audio stream to a recording medium, and a menu recording unit operable to generate control information for displaying a first menu (“Treasure Menu”) and a second menu (“Pleasure Menu”). The first menu allows selection of content from contents which are selected by the user out of contents stored in the recording medium. The second menu is selectively displayed between the first and second menus and allows selection of content from contents which are not selected by the user. The recording unit records the control information to the recording medium.

### BACKGROUND OF THE INVENTION

1. Field of the Invention

The present invention relates to an apparatus and method of recording or reproducing a selection menu for selecting one from plural contents (for example, motion picture stream) recorded to a recording medium.

2. Related Art

These days, a digital apparatus (such as an optical disk recorder, hard disk recorder, or camcorder) which writes and holds content as digital data to a recording medium such as an optical disk such as a DVD (Digital Versatile Disk) or Blu-ray™, a magnetic disk such as a hard disk, or a semiconductor memory is becoming widespread. Such content includes a broadcasted program or video and audio taken by a camcorder or the like.

When reproducing a DVD-R disk to which plural motion pictures are recorded, a reproducing apparatus generates and displays a title menu (called as a “disk menu”) for selecting a motion picture to be played back. The title menu displays thumbnail images of all contents recorded to an optical disk. The user can select the image to be played back by specifying the thumbnail image of the title menu.

Patent Document of JP-A-2005-109585 discloses a technique which creates a DVD-R disk to which a title menu is provided by a DVD recorder.

The title menu recorded to the DVD-R disk displays thumbnail images over plural pages when there are many recorded contents. Thus when many contents are recorded to the DVD-R disk, the user need to search for desired content while switching plural pages on the title menu. This is a troublesome process for the user

The present invention has been made to solve the foregoing problems and an object of the present invention is to provide a data processing apparatus and a method which can generate a menu by which the user can easily find desired content when there are many recorded contents.

### SUMMARY OF THE INVENTION

In a first aspect of the invention, an apparatus which records a content selection menu to a recording medium is provided. The apparatus includes a recording unit operable to record content including video stream and/or audio stream to a recording medium, and a menu recording unit operable to generate control information for displaying a first menu and a second menu. the first menu allows selection of content from contents which are selected by the user out of contents stored in the recording medium. The second menu is selectively displayed between the first and second menus and allows selection of content from contents which are not selected by the user. The recording unit records the control information to the recording medium.

In a second aspect of the invention, a method of recording control information of a content selection menu to a recording medium which stores a content including video stream and/or audio stream is provided. The method includes generating control information for displaying a first menu and a second menu, the first menu allowing selection of content from contents which are selected by the user out of contents stored in the recording medium, the second menu being selectively displayed between the first and second menus and allowing selection of content from contents which are not selected by the user, and recording the control information to the recording medium.

In a third aspect of the invention, provided is a recording medium storing content including video stream and/or audio stream, and control information for displaying a first menu and a second menu, the first menu allowing selection of content from contents which are selected by the user out of contents stored in the recording medium, the second menu being selectively displayed between the first and second menus and allowing selection of content from contents which are not selected by the user.

According to a fourth embodiment of the present invention, an apparatus which displays a menu for selecting a content to be played back is provided. The apparatus has a reproducing unit which reads control information from the recording medium of the third aspect of the invention, and a menu presentation unit which selectively displays the first menu and the second menu according to the read control information.

According to a fifth aspect of the present invention, a method of displaying a menu for selecting a content to be played back is provided. The method includes reading control information from the recording medium of the third aspect of the invention, and selectively displaying the first menu and the second menu according to the read control information.

A computer may be controlled by a computer program to execute the methods of the second or fifth aspect of the invention.

According to the present invention, a first selection menu (Treasure Menu) which manages contents selected (marked) by the user and a second selection menu (Pleasure Menu) which manages contents not selected (marked) by the user can be selectively displayed. Such menu display classifies and displays contents recorded to a recording medium according to preferences of the user. Accordingly, even though there are many contents, the user can easily find desired content, and convenience in browsing and selecting content for the user can be improved.

### BRIEF DESCRIPTION OF DRAWINGS

FIG. 1 is a diagram showing a configuration of a data processing apparatus according to an embodiment of the present invention.

FIG. 2 is a diagram showing a file structure on an optical disk.

FIG. 3 is a diagram for explaining the relation between motion picture streams and Treasure Menu and Pleasure Menu.

FIG. 4 is a diagram showing a display example of a title menu including Treasure Menu and Pleasure Menu.

FIG. 5 is a diagram for explaining a process executed on selection of a thumbnail on the title menu.

FIG. 6 is a diagram for explaining generation of Treasure Menu and Pleasure Menu when a part of motion picture stream is registered into a user defined playlist.

FIG. 7 is a flowchart showing a process of Java program for displaying the title menu.

FIG. 8 is a flowchart (continued from FIG. 7) a process of Java program for displaying the title menu.

FIG. 9 is a diagram showing a display example of a device menu displayed.

FIG. 10 is a flowchart showing a process about the device menu.

FIG. 11 is a diagram showing another display example of the device menu.

### DETAIL DESCRIPTION OF THE PREFERRED EMBODIMENT

Preferred embodiment of the present invention is described below with reference to the accompanying drawings.

1. Configuration

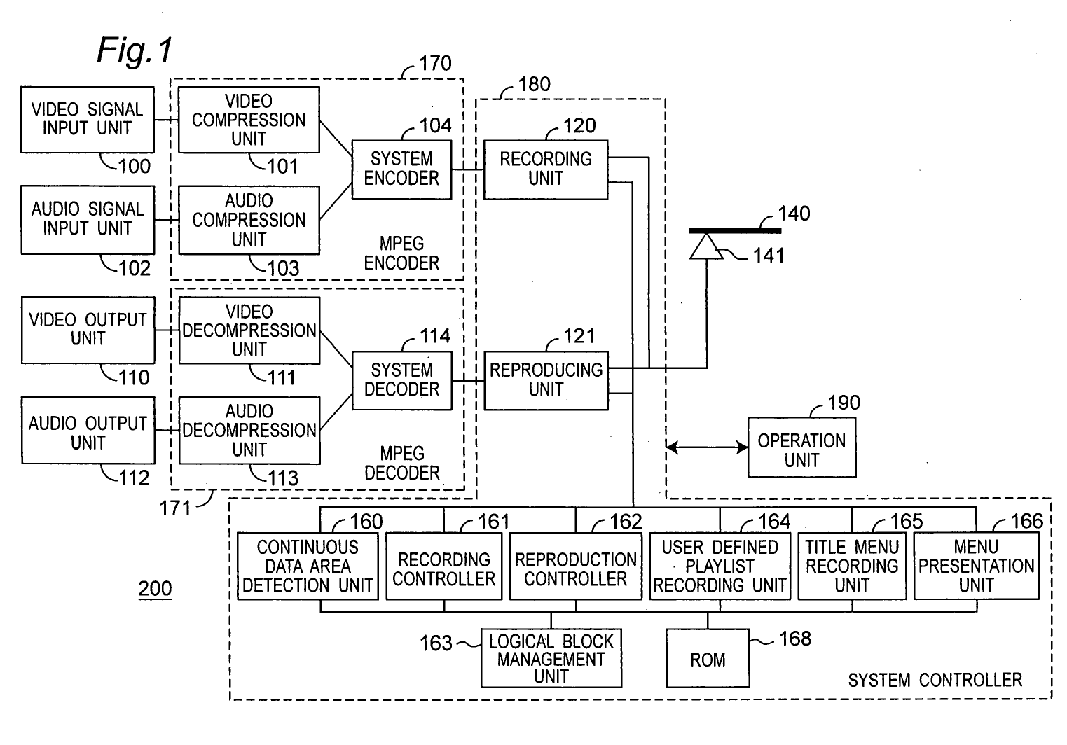

FIG. 1 is a diagram showing an example of the configuration of a data processing apparatus of the present invention. A data processing apparatus 200 is an apparatus which records or plays back content data to/from an optical disk 140 as a recording medium of video information and audio information. The data processing apparatus 200 will be described below using a motion picture stream including a video stream and an audio stream as content.

The data processing apparatus 200 has a video signal input unit 100 for inputting a video signal, an audio signal input unit 102 for inputting an audio signal, an MPEG encoder 170 compressing the video signal and audio signal, an MPEG decoder 171 for decompressing the compressed video signal and audio signal, a video output unit 110 for outputting the video signal, an audio output unit 112 outputting the audio signal, a system controller 180 for controlling recording or reproduction of data to/from the optical disk 140, and an operation unit 190 through which the user provides instruction.

The MPEG encoder 170 includes a video compression unit 101 and audio compression unit 103 for compressing the video signal and audio signal respectively according to an MPEG2 format, and a system encoder 104 for generating a transport stream from the compressed and generated video stream and audio stream.

The MPEG decoder 171 includes a system decoder 114 for extracting the video stream and audio stream from the transport stream, and a video decompression unit 111 and an audio decompression unit 113 for decompressing the compressed video signal and audio signal according to the MPEG2 format.

The system controller 180 includes a recording unit 120 for recording video and audio data to the optical disk 140, a recording controller 161 for controlling operation for data recording, a reproducing unit 121 for reproducing data recorded to the optical disk 140, and a reproduction controller 162 for controlling operation for data reproducing. The system controller 180 further includes a continuous data area detection unit 160, a logic block management unit 163, and a ROM 168 for storing control information such as a program. The continuous data area detection unit 160 searches for a free space of the optical disk 140. The logic block management unit 163 manages a logic block on the optical disk 140. The system controller 180 further includes a user defined playlist recording unit 164 for controlling recording of a user defined playlist, a title menu recording unit 165 for controlling recording of a title menu, and a menu presentation unit 166 for controlling display of a menu.

The operation unit 190 includes an operation panel having keys necessary for the user to operate the data processing apparatus 200 or a remote controller for the data processing apparatus 200.

1.1 File Structure on the Optical Disk

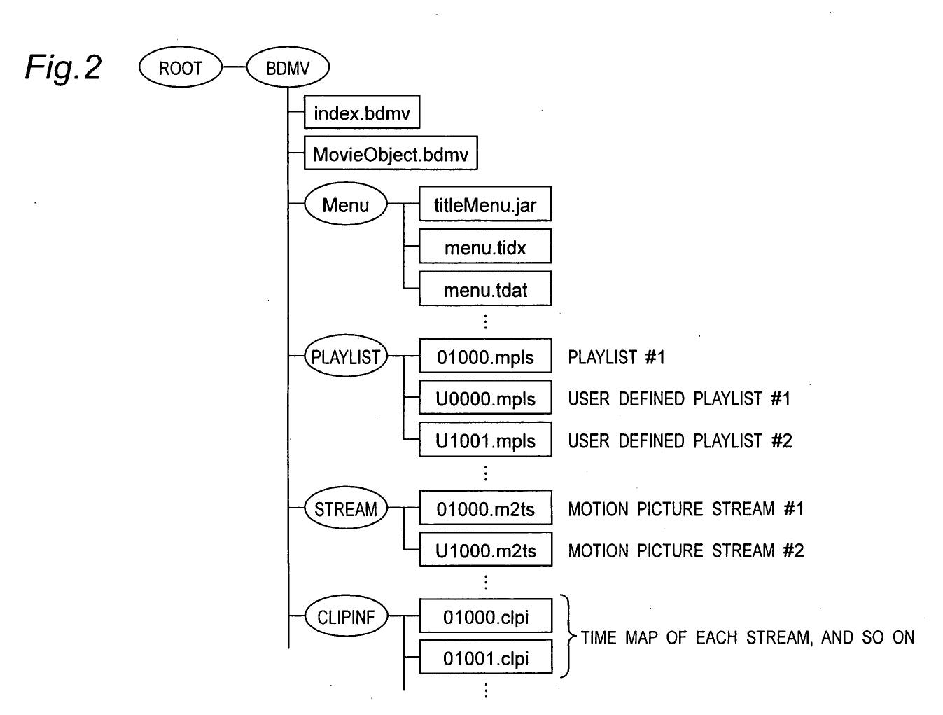

FIG. 2 shows a file structure on the optical disk 140 of this embodiment. The optical disk 140 has a ROOT directory and a BDMV directory under the ROOT directory. Various files are recorded under the BDMV directory. A list of movie objects to be reproduced is recorded into the index.bdmv file. One movie object is composed of a Java™ program or a collection of playlists. The Java™ program or a list of playlists composing a movie object is recorded into the MovieObject.bdmv file for each movie object. Movie objects not registered into the index.bdmv file are not reproduced.

The Java™ program (titleMenu.jar) for generating and displaying a title menu, a thumbnail management file (menu.tidx), and a thumbnail data file (menu.tdat) are recorded under the Menu directory. The thumbnail data file (menu.tdat) stores a representative still image (thumbnail) of each motion picture stream in JPEG format. The thumbnail management file (menu.tidx) stores information on relation between the motion picture stream and the representative still image (file name of the motion picture stream, and an address at which the thumbnail data file of the representative still image is recorded).

titlemenu.jar which is the Java program for generating and displaying the title menu (hereinafter, called a “title menu program”) uses the representative still image in the thumbnail data file to draw the title menu, and starts reproduction of the motion picture stream selected by the user. Then, it executes re-drawing of the title menu and reproduction of a different motion picture stream, according to description of the title menu program. When the optical disk 140 is loaded into the data processing apparatus, the titlemenu.jar file is referred to by the index.bdmv file and MovieObject.bdmv file, as a movie object for controlling display of the menu to be displayed first.

The PLAYLIST directory stores a playlist file (*.mpls) for defining a playlist. The playlist is information defining a playback order of a motion picture stream and a portion (section) to be played back. The playlist includes a playlist which is automatically generated and updated by the data processing apparatus when the motion picture stream is recorded to the optical disk 140 by the data processing apparatus, and a playlist (general playlist) which is defined by the user. Hereinafter, the latter will be called as a “user defined playlist”. In this embodiment, the general playlist and the user defined playlist can be discriminated by the file name.

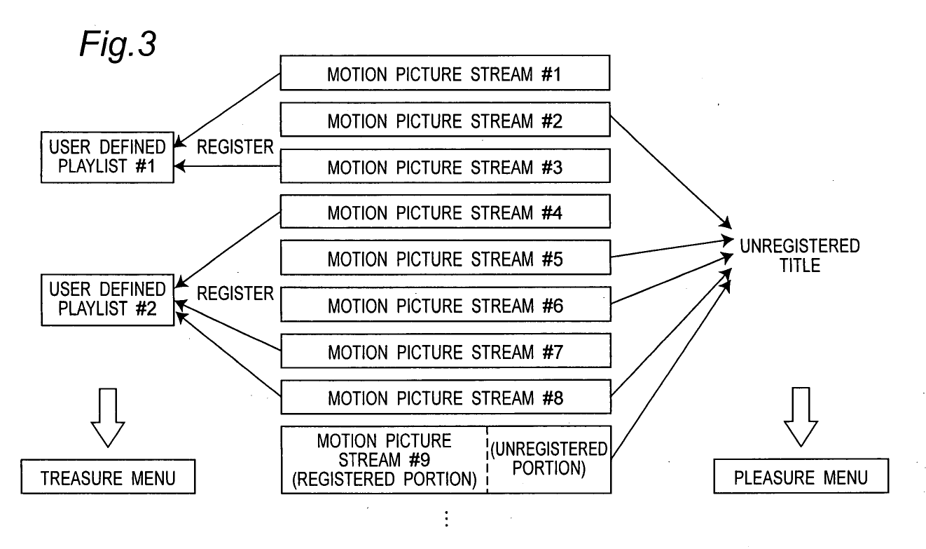

Here, the user defined playlist will be described with reference to FIG. 3. In the drawing, the file names of the motion picture streams #1 and #3 are registered into the user defined playlist #1. The file names of the motion picture streams #4 and #7 are registered into the user defined playlist #2. The file name of the motion picture stream #9 and information showing the section of playback part of the motion picture stream #9 are recorded into the user defined playlist #2. The motion picture streams #2, #5, #6, and #8 are not registered into the user defined playlist. As described later, in this embodiment, motion picture streams registered into the user defined playlist make “Treasure Menu” and motion picture streams not registered into the user defined playlist make “Pleasure Menu”.

Returning to FIG. 2, the STREAM directory stores a motion picture stream (*.m2ts). The CLIPINF directory stores a management data file (*.clip) related to the motion picture stream. The motion picture stream is stored in transport stream format

The optical disk 140 is formatted in UDF (Universal Disk Format) file system format. A logic block which is a management unit of a free space and a unit of area allocation is 2 k bytes.

1.2 Title Menu

A title menu which is a content selection menu is also called a “disk menu”, and is generated and displayed by the titlemenu.jar file which is recorded to the optical disk 140. Any data processing apparatus which can execute the titleMenu.jar file (Java file) recorded to the optical disk 140 can display a title menu having the same outer shape and function.

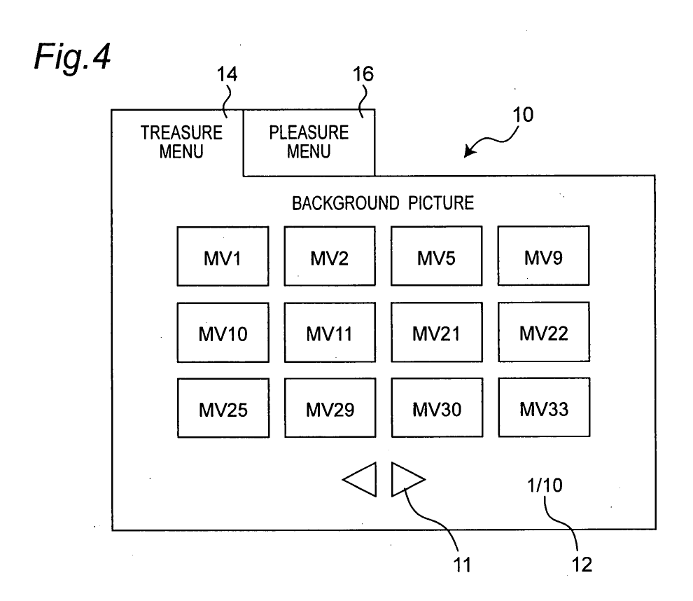

FIG. 4 shows a display example of a title menu provided by the data processing apparatus 200 of this embodiment. A title menu 10 provided by this embodiment includes two types of menus: “Treasure Menu” and “Pleasure Menu”. “Treasure Menu” is a menu for selecting a motion picture stream registered into the user defined playlist, and “Pleasure Menu” is a menu for selecting a motion picture stream not included in “Treasure Menu”.

A motion picture stream which is intentionally registered into the user defined playlist by the user seems to be of great interest to the user and generally considered to have a high reproduction frequency. Accordingly, using Treasure Menu which collects only motion picture streams registered into the user defined playlist, the user can select a motion picture stream with a high reproduction frequency more easily.

The title menu 10 has a tab 14 for selection of Treasure Menu and a tab 16 for selection of Pleasure Menu. The title menu 10 includes page up/down buttons 11, and page indication (page number/total number of pages in display) 12. Thumbnail images MV1, MV2, . . . in 4 columns×3 rows arrangement are drawn over a background picture. The thumbnail images MV1, MV2, . . . correspond to the playlist. The thumbnail images displayed on “Treasure Menu” are composed of thumbnail images of motion picture streams which have been registered into the user defined playlist by the user. Thumbnail images displayed on “Pleasure Menu” are composed of thumbnail images of motion picture streams which have not been registered into the user defined playlist.

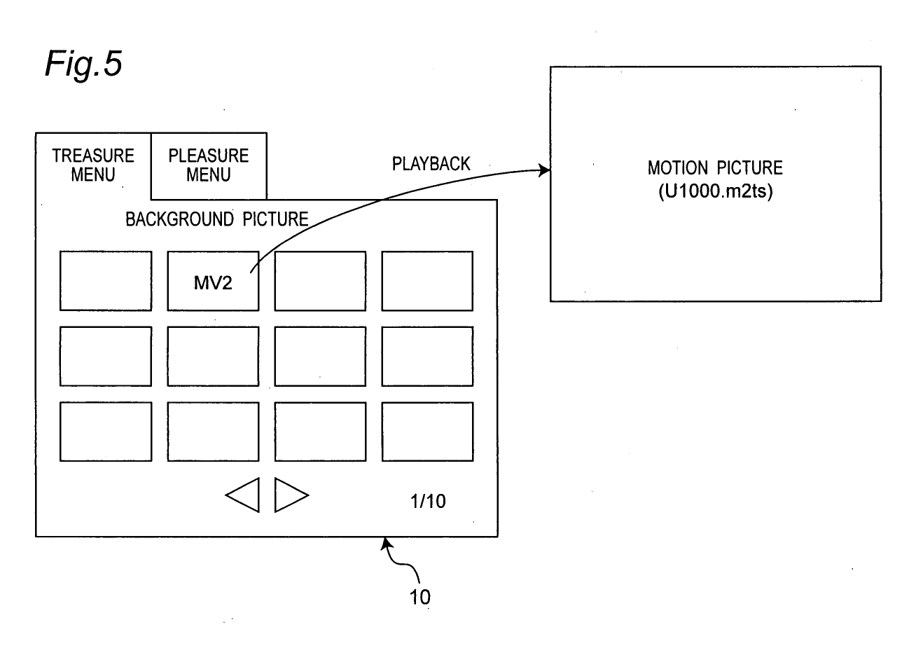

When the user selects one thumbnail image using the remote controller of the data processing apparatus 200, a motion picture stream corresponding to the thumbnail image is played back. For instance, as shown in FIG. 5, when the thumbnail image MV2 as a thumbnail image corresponding to the user defined playlist U1000.mpls is selected, playback of the motion picture stream U1000.m2ts corresponding thereto is started. After completion of playback of the motion picture stream U1000.m2ts, the title menu 10 is displayed again.

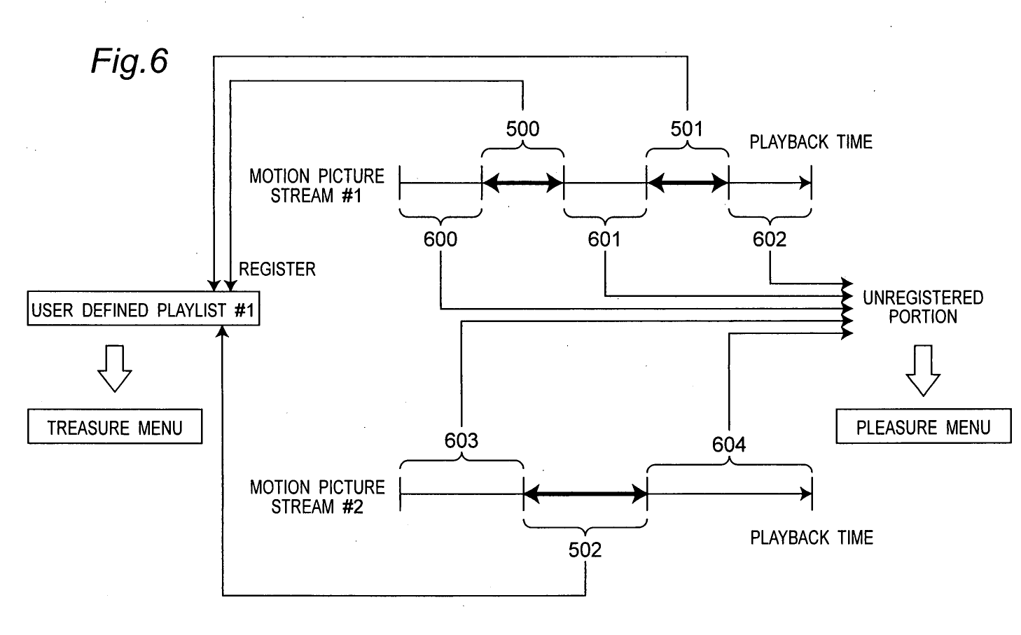

When a specific section of part of a motion picture stream is registered into the user defined playlist, only the specific sections compose “Treasure Menu” and unregistered sections compose “Pleasure Menu”. FIG. 6 shows an example in which the specific sections of part of a motion picture stream are registered into the user defined playlist. Sections 500 and 501 in the motion picture stream #1 and a section 502 in the motion picture stream #2 are registered into the user defined playlist #1. Sections 600, 601, and 602 in the motion picture stream #1 and sections 603 and 604 in the motion picture stream #2 are not registered into the user defined playlist. Treasure Menu is composed of the sections 500 to 502 registered in the user defined playlist, and Pleasure Menu is composed of the unregistered sections 600 to 604.

2. Operation

The operation of the data processing apparatus 200 is described below.

2.1 Content Recording Operation

The operation of recording a motion picture to the optical disk 140 is described. The recording controller 161 in the system controller 180 mainly performs control for recording the motion picture.

The signals inputted from the video signal input unit 100 and the audio signal input unit 102 are compressed by the video compression unit 101 and the audio compression unit 103, respectively. The system encoder 104 creates a transport stream from the compressed signals. The created transport stream is recorded to the optical disk 140 through the recording unit 120 and a pickup 141.

Before starting recording of the transport stream, the recording controller 161 activates the continuous data area detection unit 160 to search for a free space of the optical disk 140. The continuous data area detection unit 160 checks a space bit map managed by the logic block management unit 163 and read from the optical disk 140 to detect a successive free space.

The recording controller 161 starts recording of the transport stream into the free space of the optical disk 140 detected as a searched result. While the next free space is continuously searched, recording of the transport stream is continued. When recording of the transport stream is completed, UDF file management information is written to the optical disk 140 to complete recording of the transport stream file (*.m2ts file, that is, a file storing the motion picture stream).

The stream management data file (*.clipi) corresponding to the recorded transport stream is recorded to the optical disk 140. The playlist file (*.mpls) corresponding to the recoded transport stream is recorded. Further, the thumbnail managing file (menu.tidx) and the thumbnail data management file (menu.tdat) including the thumbnail image corresponding to the playlist file are recorded to the optical disk 140. The playlist file specifies a specific playback range in the transport stream file. In this embodiment, immediately after completion of recording the motion picture, a range for playback ranges from the head to the end of the transport stream.

2.2 Content Playback Operation

The playback operation of a motion picture recorded to the optical disk 140 is described. For playback, the reproduction controller 162 in the system controller 180 mainly performs control.

The menu presentation unit 166 displays the title menu or device menu according to user's selection.

When the device menu is selected, the menu presentation unit 166 displays the device menu according to the program stored in the ROM 168. The device menu is different from the title menu, is an operation menu inherently provided to the data processing apparatus 200, and is a menu displayed according to the program pre-stored in the ROM 168. This menu is called “device menu” for convenience of explanation and is discriminated from the title menu of which procedures are determined by the title menu program recorded under the Menu directory. The process related to the device menu is stored in, for instance, the ROM 168 of the data processing apparatus 200. The detail of the process of the device menu is described later.

When the title menu is selected, the title menu recording unit 165 checks whether or not the title menu program file (titileMenu.jar) is recorded to the optical disk 140. When the title menu program file is not recorded, the Java program for displaying the title menu stored in the ROM 168 of the data processing apparatus 200 is read out and is recorded as the titlemenu.jar to the optical disk 140 via the recording unit 180. The Java program is source code which has been already complied, and is stored as the titleMenu.jar file together with a class library to be referred to. When the title menu program file is recorded, the menu presentation unit 166 displays the title menu according to the title menu program.

When the user selects content (title) to be played back through the operation unit 190 on the title menu or the device menu in display, under control of the reproduction controller 162, the reproduction unit 121 reads management information of a data stream corresponding to the selected content from the management file and refers to address information described in the management file to read a transport stream. The system decoder 114 separates the read transport stream into a video signal and an audio signal, decompresses them by the video decompression unit 111 and the audio decompression unit 113, and outputs them to the video output unit 110 and the audio output unit 112.

The user defined playlist recording unit 164 registers a list of file names of motion picture streams selected by the user as the user defined playlist. Alternatively, the user defined playlist recording unit 164 registers a list of the specific sections or all sections of motion picture streams as the user defined playlist. As shown in FIG. 2, the user defined playlist (for example, U1000.mpls) is placed under the PLAYLIST directory and has the same data structure as that of the general playlist file (for example, 01000.mpls) corresponding to a motion picture stream.

2.3 Process of the Title Menu Program

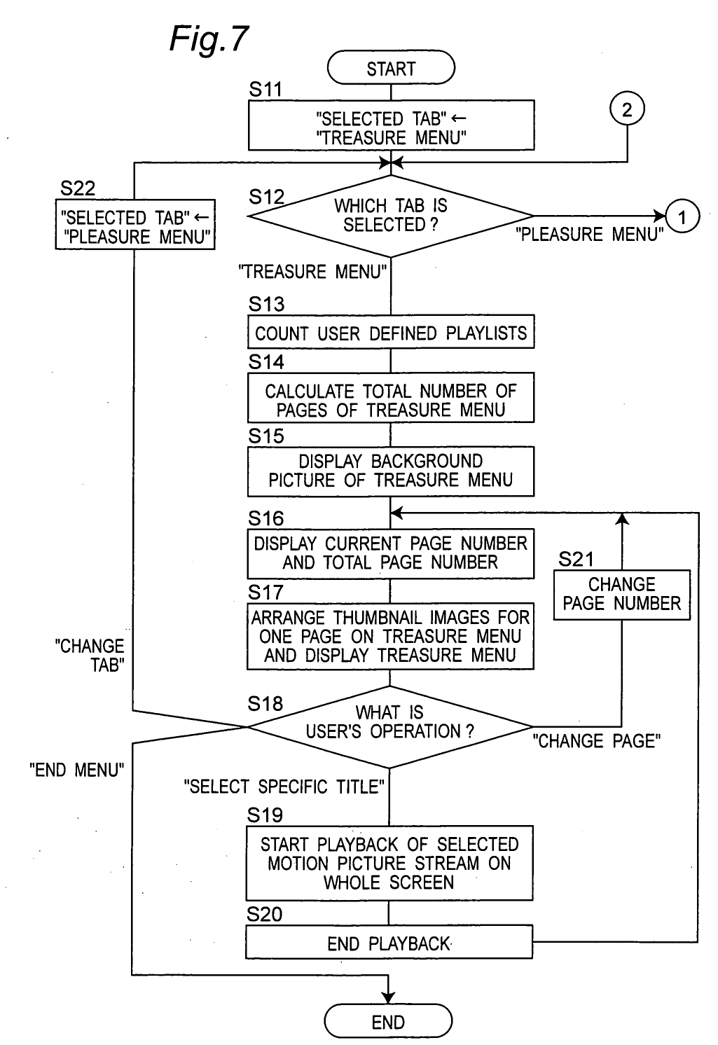

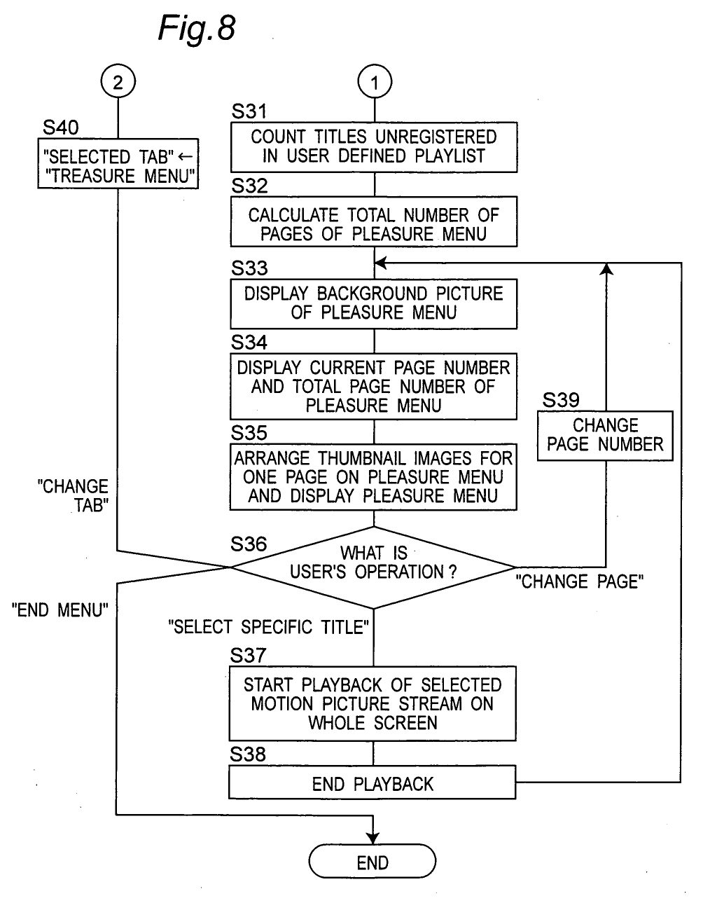

FIGS. 7 and 8 are flowcharts showing the process of the title menu program (titleMenu.jar).

The title menu program sets, as an initial value, a status of “selected tab” as a status in which “Treasure Menu” is selected (S11). Then, the status of selected tab is judged. That is, whether “Treasure Menu” is selected or “Pleasure Menu” is selected is judged (S12).

When “Pleasure Menu” is selected, the process shown in FIG. 8 is executed.

When “Treasure Menu” is selected, user defined playlist files under the PLAYLIST directory are counted (S13). The user defined playlist and the general playlist can be discriminated by file names.

The total number of pages necessary for displaying the thumbnail images of all user defined playlists is calculated (S14). In this example, 12 (4 columns×3 rows) thumbnail images are displayed on one page. The background picture of Treasure Menu is drawn (S15). Then, the current page number and the total number of pages of Treasure Menu are displayed (S16). Twelve (4 columns×3 rows) thumbnail images are arranged in one page to draw Treasure Menu (S17), and the menu waits for selecting operation of a title (motion picture stream) by the user (S18).

When the user selects a specific title, playback of the motion picture stream corresponding to the selected title using the entire screen is started (S19). When the playback of the motion picture stream is completed (S20), Treasure Menu is displayed again (S15).

When the user does not select the title but selects page change (S18), Treasure Menu in which the thumbnail images of the motion picture streams corresponding to the next page are arranged is drawn again (S21, S15).

Alternatively, when the user selects end of the title menu (S18), execution of the title menu program is ended.

Alternatively, when the user switches Treasure Menu tab 14 to Pleasure Menu tab 15 (S18), the “selected tab” is set to “Pleasure Menu” (S22) to execute the process shown in FIG. 8 (S12).

In FIG. 8, the total number of motion picture streams (titles) not registered into the user defined playlist is counted (S31). As in the process of FIG. 7, the total number of necessary pages of Pleasure Menu is calculated (S32). Pleasure Menu is displayed in the same procedure as that of FIG. 7 (S33 to S39). When the user switches Pleasure Menu tab 15 to Treasure Menu tab 14, the status of selected tab is set to “Treasure Menu” (S40) to return to the process of FIG. 7.

2.4 Display of Device Menu

2.4.1 Device Menu

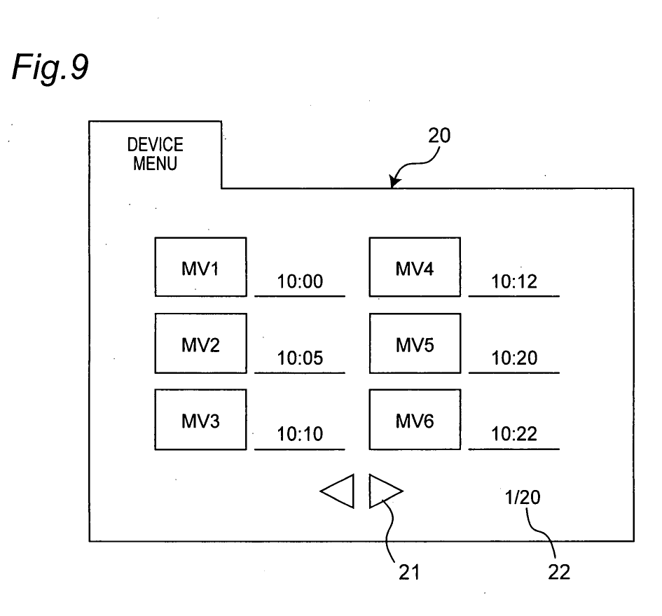

The data processing apparatus 200 has a menu (device menu) for performing an operation dedicated to the apparatus. FIG. 9 shows a display example of a general device menu. An device menu 20 displays plural thumbnail images and recording time of motion pictures corresponding to the thumbnail images on the right side of the thumbnail images. As in the title menu 10, the device menu 20 includes page up/down buttons 21 and page indication 22. In this example, the number of thumbnail images displayed per page is six.

2.4.2 Process Related to the Device Menu

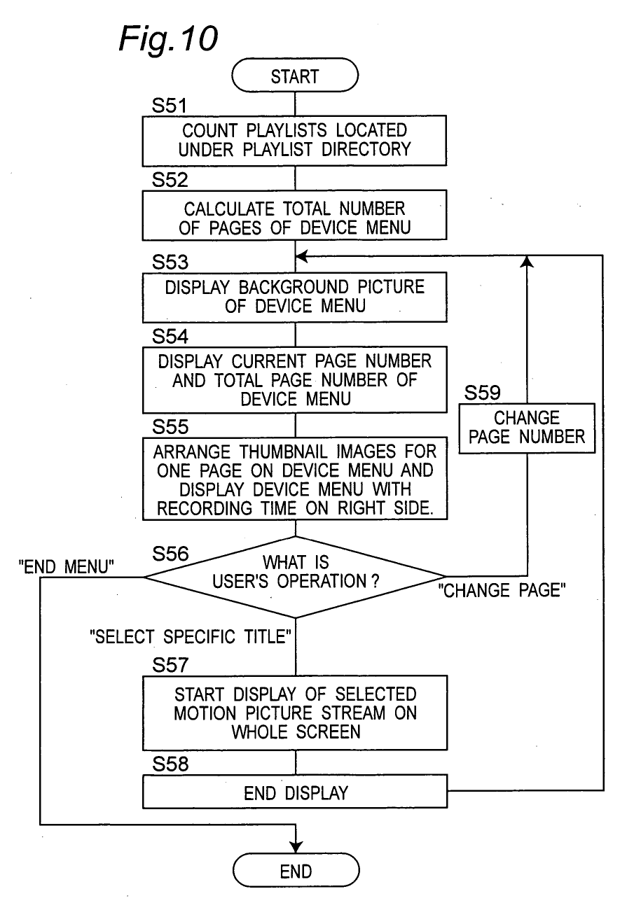

FIG. 10 shows a process of displaying a device menu by the menu presentation unit 166 of the data processing apparatus 200. The process of FIG. 10 is a process executed by the menu presentation unit 166 of the data processing apparatus 200 but not by the title menu program.

In FIG. 10, the number of all playlists excluding the user defined playlist under the PLAYLIST directory is counted (S51). The total number of pages of the device menu necessary for displaying all playlists excluding the user defined playlist is calculated (S52). In this example, six (2 columns×3 rows) thumbnail images are displayed per page. The background picture of the device menu 20 is drawn (S53), and the current page number and the total number of pages of the device menu are displayed (S54). Six (2 columns×3 rows) thumbnail images are arranged per page and recording time is arranged on the right side of each of the thumbnail image to draw the device menu (S55). The menu waits for selection operation of a title (motion picture stream) by the user (S56).

When the user selects a specific title, playback of the motion picture stream corresponding to the selected title using the entire screen is started (S57). When the playback is completed (S58), the device menu is drawn again (S53).

When the user does not select the title but selects page change (S56), Treasure Menu in which the thumbnail images of the motion picture streams corresponding to the next page are arranged is drawn again (S59, S53).

Alternatively, when the user selects end of the title menu (S56), this process is ended.

As shown in FIG. 4, Treasure Menu and Pleasure Menu to be displayed may be switched with the tabs 14 and 15.

2.4.3 Other Operations

When the optical disk 140 is loaded into the data processing apparatus 200 shown in FIG. 1 or the data processing apparatus 200 is turned on, the title menu recording unit 165 checks whether or not the UDF file system of the optical disk 140 is normally recorded, and then checks whether or not the title menu program file (titileMenu.jar) is recorded to the optical disk 140. When the title menu program file is not recorded, the Java program for displaying the title menu stored in advance in the ROM 168 incorporated in the data processing apparatus 200 is recorded as the titlemenu.jar to the optical disk 140.

When the title menu program file is recorded, the menu presentation unit 166 executes the title menu program and displays the title menu 10 shown in FIG. 4.

When the user starts the recording operation, a motion picture stream is recorded. Then, when the user completes the recording process, a reduced image of the video frame which is to be played back at one second from the head of the motion picture stream, is stored as JPEG compressed thumbnail data to the thumbnail data file (menu.tdat).

When the user erases a specific motion picture stream, the erased motion picture stream and the thumbnail image corresponding thereto are erased. When the user instructs an edit process for erasing the first half of the specific motion picture stream and if the corresponding thumbnail image corresponds to the video of the erased portion, the thumbnail image is regenerated.

When the user selects the reproduction mode on the data processing apparatus 200, the menu presentation unit 166 displays the device menu 20 as shown in FIG. 9.

When the user takes out the optical disk 140 from the data processing apparatus 200 and loads it into a different data processing apparatus (for example, BD-ROM player), the different data processing apparatus reads titlemenu.jar file recorded to the optical disk 140 to display the title menu according to it. When the optical disk 140 is taken out from the data processing apparatus 200 and is browsed with the different data processing apparatus, the title menu is always displayed.

When the data processing apparatus 200 reproduces the optical disk 140 to display a list of the recorded motion picture streams, the display program of the device menu stored in the ROM 168 of the data processing apparatus 200 executes drawing of the list display menu by referring to the thumbnail data file (menu.tdat) and the thumbnail management file (menu.tidx).

3. Summary

As described above, the data processing apparatus of this embodiment automatically generates not only “Treasure Menu” composed of motion picture streams selected by the user, but also “Pleasure Menu” composed of motion picture streams not selected by the user. This classifies contents in the disk into two groups. Therefore, even though there are many contents, content selection is easy and convenience in browsing and selecting content can be improved. The user who is tired of browsing Treasure Menu can browse Pleasure Menu, thereby doubling enjoyment. With these effects, the user becomes to be able to easily view motion pictures which are left with little playback frequency after recording in the prior manner. In this embodiment, “Pleasure Menu” is automatically created for contents not specified by the user. Therefore, the user has only to specify desired contents to automatically prepare two kinds of menus, thereby reducing the operation load of the user.

4. Modifications

The following modifications can be considered in the above embodiment.

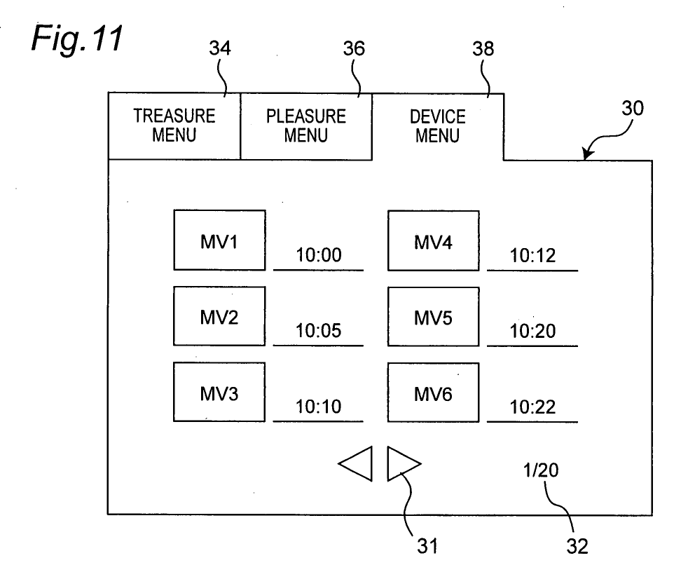

(1) As shown in FIG. 11, “Treasure Menu” and “Pleasure Menu” may be selected with tabs 34, 36, and 38 together with a device menu 30. In this case, in addition to the process shown in FIG. 10, the processes of FIGS. 7 and 8 need to be executed by the menu presentation unit 166. Alternatively, the title menu program needs to be executed by the data processing apparatus 200.

(2) According to this embodiment, the tabs 14 and 15 are used for switching Treasure Menu and Pleasure Menu in the title menu. Alternatively, they may be switched upon selection of a thumbnail image representing each menu on the top menu (the first page of the title menu).

(3) According to this embodiment, one kind of the title menu 10 and the device menu 30 are provided respectively. Alternatively, plural kinds of them may be provided. In that case, in FIGS. 9 and 11, two or four or more menu selection tabs are displayed, respectively.

(4) Different graphic display and music data may be used in the title menu 10 and the device menu 30.

(5) According to this embodiment, plural thumbnail data are stored in one thumbnail data file. Alternatively, plural thumbnail data may be stored in the respective thumbnail data files for each motion picture stream.

(6) The thumbnail data file and the thumbnail management file are prepared independent of the titlemenu.jar file, but may be included in the titlemenu.jar file. This can be applied to a case for recording thumbnail data into the respective thumbnail data files for each motion picture stream.

(7) According to this embodiment, a removable optical disk is used as a recording medium storing a data stream. However, the optical disk needs not be removable and may be a non-removable medium, for example, an HDD incorporated in a data processing apparatus. In this case, a data processing apparatus is connected to a network and a different data processing apparatus refers to a title menu program in the data processing apparatus to execute it on the different data processing apparatus.

(8) The recording medium may be a memory card, flash memory, semiconductor memory such as FeRAM or MRAM, or a hard disk, in addition to the optical disk. The optical disk 140 includes a DVD-RAM, MO, DVD-R, DVD-RW, DVD+RW, DVD+R, CD-R, CD-RW, BD-RE, BD-R, and HD-DVD.

(9) Other kinds of file systems having the same structure may be used in place of the UDF file system.

(10) The configuration shown in FIG. 1 is typically realized as a chip of an integrated circuit (LSI: Large Scale Integrated Circuit). These units may be configured of one chip individually for each function block, or may be configured of one chip so as to include some or all configurations. For instance, in FIG. 1, the MPEG encoder unit 170 and the system controller 180 are shown as individual function blocks. These may be mounted as individual semiconductor chips or may be realized by physically the same chip. The functions of the system controller 180, the MPEG encoder 170, and the MPEG decoder 171 may be integrated to be realized as one chip circuit. Only a memory storing data to be encoded or decoded, for example, may be excluded from blocks to be integrated.

The system controller 180 can achieve the function described in this specification by executing the computer program stored in the ROM 168 and the like.

The above-described “LSI” can be also called an IC, system LSI, super LSI, or ultra LSI due to difference in integration degree. The circuit integration method is not limited to LSI but may be realized with a dedicated circuit or a general-purpose processor. FPGA (Field Programmable Gate Array) permitting programming after manufacture of LSI and a reconfigurable processor which can reconfigure connection and setting of circuit cells in LSI may also be used.

Further, when a circuit integration technique in place of LSI by advancement in the semiconductor technique or a different technique derived therefrom appears, the function blocks may be integrated using such technique. For instance, integration may be performed as a so-called bio-device using biotechnology.

(11) According to this embodiment, the transport stream is assumed as a data stream. The data stream may be other bit streams such as a program stream, PES stream, QuickTime stream, MP4 stream, AVI stream, ASF stream, or MotionJPEG stream.

(12) According to this embodiment, the video information is carried in the MPEG-2 video stream as an example. It may be an MPEG-4 video stream or MPEG-4AVC (H. 264) stream. In addition, the information data may be carried in a linear PCM audio stream, AC-3 stream, and the like. Other multimedia information (graphics information, text information, and the like) other than the video or audio information may be included.

(13) According to this embodiment, one transport stream can be stored in one data stream file. Alternatively, plural transport streams may be composed of one data stream file.

(14) According to this embodiment, the title menu program drawing the title menu is recorded when the optical disk is loaded. Alternatively, this may be done on completion of formatting of the optical disk or on receipt of instruction with user's operation.

(15) According to this embodiment, the title menu program is recorded by a movie or recorder for recording a motion picture stream. Alternatively, a data processing apparatus (recorder, camcorder, or personal computer and the like) different from the data processing apparatus which records a motion picture stream to the optical disk may record only the title menu program.

(16) According to this embodiment, any video compression code of a motion picture stream which can be played back by a player such as an MPEG-2 video, MPEG-4AVC, MPEG-4 visual, VC-1 and the like may be used.

(17) According to this embodiment, one example of the title menu is shown in FIG. 4. It is understood that the Java program using graphics data or motion picture data recorded to the ROM of the data processing apparatus may be recorded to the optical disk so as to create a title menu which is distinctive and of higher quality.

(18) According to this embodiment, the data processing apparatus may use a GUI library such as Swing realized by a personal computer. The data processing apparatus may separately use a class library permitting Internet access as included in the BD-ROM standards.

(19) The data processing apparatus is, for instance, a video camcorder, DVD recorder, BD-ROM decoder, BD-ROM player, or personal computer.

(20) According to this embodiment, the version of the UDF file system may be any one of 1.5, 2.0, 2.01, 2.5, and 2.6. In particular, the version 2.6 is useful because it needs no writing process of the file management data in write once media.

(21) According to this embodiment, the title menu is displayed by executing the Java™ program by the player. Alternatively, any program providing the same function and is described in XML language or XHTML language may be used.

(22) According to this embodiment, the device menu and the title menu are selected by the tabs. Alternatively, this may be performed by a dedicated button or an operation remote controller provided to the data processing apparatus. For instance, when the “top menu” button of the remote controller is pressed once, the title menu is displayed, and when it is pressed once again, the device menu may be displayed.

(23) According to this embodiment, the title menu is described by the title menu program which is Java program. In place of that, this may be executed using a data stream for displaying a menu. In this case, graphics data for displaying a title menu, an operation command after a thumbnail image is selected, and the like need to be multiplexed into the data stream. Examples of such data stream include a title menu of the DVD-Video standards and a title menu in the HD movie mode of the BD-ROM standards. When part of content on the optical disk is erased, care need to be taken so that no contradictito the menu created in such manner occurs.

(24) According to this embodiment, the device menu is displayed first. Alternatively, the title menu may be displayed first.

(25) According to this embodiment, motion picture streams which are registered to the user defined playlist are registered to “Treasure Menu”. Alternatively, the user may register a motion picture stream to any one of plural groups as necessary, and menus may be provided for each group. In this case, “Pleasure Menu” may be composed of motion picture streams which do not belong to any groups.

(26) According to this embodiment, additional information (meta data) may be added to each motion picture stream and be recorded to the optical disk. With reference to the additional information, Treasure Menu may be generated from motion picture streams specified by the additional information. Alternatively, information showing that each motion picture stream is selected by the user may be recorded to management information. With reference to the management information, Treasure Menu may be generated from the motion picture streams.

(27) According to this embodiment, a motion picture stream may be a data stream including only one of a motion picture, a still image, and audio.

(28) According to this embodiment, when contents recorded to the optical disk are copied to a different recording medium, the title menu program may also be recorded to the different recording medium. For instance, when contents are copied using a personal computer, or when contents on the optical disk are once copied to a hard disk by a different data processing apparatus and then copied to another optical disk, the title menu program may be recorded together.

(29) According to this embodiment, when the user instructs title menu creation, the title menu program may be created. In this case, when the optical disk is loaded to a data processing apparatus different from a recording apparatus which recorded motion pictures to the optical disk before the instruction by the user, the title menu may not be displayed even when the top menu button is pressed by the user, and only the recorded motion picture streams may be sequentially played back.

### INDUSTRIAL APPLICABILITY

The present invention can be applied to a recording technique for recording contents to a recording medium. In particular, the present invention provides a recording medium capable of displaying a selection menu which can improve convenience of the user in content selection. Therefore, it is useful for a technique for recording contents to a recording medium which is removable and can be reproduced by various reproducing apparatuses such as an optical disk.

The specific embodiments of the present invention are described above, however, many other modifications, changes, and other utilization are apparent to those skilled in the art. The present invention is not limited to the specific disclosure herein and can be limited only in the scope of the accompanying claims. The present application is related to Japanese patent application No. 2005-357416 (filed on Dec. 12, 2005), the content of which is hereby incorporated by reference.

What is claimed is:

1. An apparatus which records a content selection menu to a recording medium, comprising:
a recording unit operable to record content including video stream and/or audio stream to a recording medium; and
a menu recording unit operable to generate control information for displaying a first menu and a second menu, the first menu allowing selection of content from contents which are selected by the user out of contents stored in the recording medium, the second menu being selectively displayed between the first and second menus and allowing selection of content from contents which are not selected by the user,
wherein the recording unit records the control information to the recording medium.

2. The apparatus according to claim 1, wherein the contents which are selected by the user include section of part of content selected by the user.

3. The apparatus according to claim 1, wherein the first menu and the second menu can be switched with tabs.

4. A method of recording control information of a content selection menu to a recording medium which stores a content including video stream and/or audio stream, comprising:
generating control information for displaying a first menu and a second menu, the first menu allowing selection of content from contents which are selected by the user out of contents stored in the recording medium, the second menu being selectively displayed between the first and second menus and allowing selection of content from contents which are not selected by the user; and
recording the control information to the recording medium.

5. The method according to claim 4, wherein the contents which are selected by the user include section of part of content selected by the user.

6. The method according to claim 4, wherein the first menu and the second menu can be switched with tabs.

7. A program for recording control information of a content selection menu to a recording medium which stores a content including video stream and/or audio stream, the program allowing a computer to execute the functions of:
generating control information for displaying a first menu and a second menu, the first menu allowing selection of content from contents which are selected by the user out of contents stored in the recording medium, the second menu being selectively displayed between the first and second menus and allowing selection of content from contents which are not selected by the user; and
recording the control information to the recording medium.

8. An integrated circuit comprising:
a recording controller operable to control recording a content including video stream and/or audio stream to a recording medium; and
a menu recording unit operable to generate control information for displaying a first menu and a second menu, the first menu allowing selection of content from contents which are selected by the user out of contents stored in the recording medium, the second menu being selectively displayed between the first and second menus and allowing selection of content from contents which are not selected by the user,
wherein the recording controller controls the recording to record the control information to the recording medium.

9. A recording medium storing:
content including video stream and/or audio stream; and
control information for displaying a first menu and a second menu, the first menu allowing selection of content from contents which are selected by the user out of contents stored in the recording medium, the second menu being selectively displayed between the first and second menus and allowing selection of content from contents which are not selected by the user.

10. An apparatus which displays a menu for selecting a content to be played back from contents stored in a recording medium, wherein
the recording medium stores:
content including video stream and/or audio stream; and
control information for displaying a first menu and a second menu, the first menu allowing selection of content from contents which are selected by the user out of contents stored in the recording medium, the second menu being selectively displayed between the first and second menus and allowing selection of content from contents which are not selected by the user, and
the apparatus comprises:
a reproducing unit operable to read the control information from the recording medium; and
a menu presentation unit operable to selectively display the first menu and the second menu according to the read control information.

11. The apparatus according to claim 10, wherein a thumbnail image corresponding to the content which can be selected in each of first and second menus is arranged in the first and second menus, and
when the thumbnail image is selected, the reproducing unit plays back the content corresponding to the selected thumbnail image.

12. A method of displaying a menu for selecting a content to be played back from contents stored in a recording medium, wherein
the recording medium stores:
content including video stream and/or audio stream; and
control information for displaying a first menu and a second menu, the first menu allowing selection of content from contents which are selected by the user out of contents stored in the recording medium, the second menu being selectively displayed between the first and second menus and allowing selection of content from contents which are not selected by the user, and
the method comprises:
reading the control information from the recording medium; and
selectively displaying the first menu and the second menu according to the read control information.

13. The method according to claim 12, wherein a thumbnail image corresponding to the content which can be selected in each of first and second menus is arranged in the first and second menus, and
when the thumbnail image is selected, the reproducing unit plays back the content corresponding to the selected thumbnail image.

14. An integrated circuit which displays a menu for selecting a content to be played back from contents recorded to a recording medium, wherein
the recording medium stores:
content including video stream and/or audio stream; and
control information for displaying a first menu and a second menu, the first menu allowing selection of content from contents which are selected by the user out of contents stored in the recording medium, the second menu being selectively displayed between the first and second menus and allowing selection of content from contents which are not selected by the user, and
the integrated circuit has a menu presentation unit operable to read the control information from the recording medium and performs control so as to selectively display the first menu and the second menu according to the read control information.

15. A program for displaying a menu for selecting a content to be played back from contents stored in a recording medium, wherein
the recording medium stores:
content including video stream and/or audio stream; and
control information for displaying a first menu and a second menu, the first menu allowing selection of content from contents which are selected by the user out of contents stored in the recording medium, the second menu being selectively displayed between the first and second menus and allowing selection of content from contents which are not selected by the user, and
the program allows a computer to execute the functions of:
reading the control information from the recording medium; and
selectively displaying the first menu and the second menu according to the read control information.
